(19) United States
(12) Patent Application Publication
(10) Pub. No.: US 2026/0187760 A1
(43) Pub. Date: Jul. 2, 2026

(54) APPARATUS AND METHOD FOR MOTION ARTIFACT CORRECTION IN LISSAJOUS SCANNING

(71) Applicant: VPIX MEDICAL INCORPORATION, Daejeon (KR)

(72) Inventors: Yeongryeol KIM, Daejeon (KR); Kyuyoung KIM, Daejeon (KR); Kyungmin HWANG, Daejeon (KR)

(21) Appl. No.: 19/200,914

(22) Filed: May 7, 2025

(30) Foreign Application Priority Data
Dec. 30, 2024 (KR) 10-2024-0200313

(51) Int. Cl. G06T 5/50; G06T 7/246; G06T 7/30; H04N 23/56

(52) U.S. Cl. CPC G06T 5/50; G06T 7/246; G06T 7/30; H04N 23/56

(57) ABSTRACT

According to an embodiment of the present disclosure, an image generation device providing a motion artifact correction function is disclosed. The device comprises a light generation unit configured to emit light irradiated onto a target object, a light receiving unit configured to receive optical signals reflected from the target object, a driving unit configured to control a light propagation path, and at least one processor. The processor is configured to irradiate light onto the target object to generate at least one scanning image, estimate a motion speed, generate a corrected scanning image by correcting the at least one scanning image based on the estimated motion speed, and generate a final corrected image based on the at least one corrected scanning image.

Also disclosed is a method for operating the image generation device.

### CROSS-REFERENCE TO RELATED APPLICATIONS

This application claims priority under 35 U.S.C. § 119(a) to Korean Patent Application No. 10-2024-0200313, filed on Dec. 30, 2024 in the Korean Intellectual Property Office, the disclosures of which are incorporated by reference herein in their entireties.

### BACKGROUND

### 1. Field

The present disclosure relates to a method and an apparatus for generating high-quality images by compensating for motion artifacts that may occur in a Lissajous scanning-based image generation device.

### 2. Description of Related Art

The image generation device is configured to irradiate light onto a target object to acquire an image of the target object, and is widely used in various fields such as LiDAR and optical microscopy. Korean Patent No. 10-2374439 discloses a technique for reconstructing an image by adjusting the phase and frequency of a signal received from the target object using the image generation device.

This technique provides a foundation for generating high-resolution images by accurately reconstructing signals from the target object.

However, in practical applications of image generation based on Lissajous scanning, the signal intensity at specific points may vary over time due to motion caused by user manipulation of the image generation device. Without accounting for such motion, phase errors may occur during reconstruction, resulting in degradation of image quality.

To address this issue, the present disclosure proposes an improved technique that additionally includes motion artifact compensation and inter-frame registration, thereby enhancing the performance of conventional technologies.

### SUMMARY

An object of the present disclosure is to provide an image generation device capable of enhancing image quality by precisely compensating for motion artifacts that occur during Lissajous scanning.

Another object of the present disclosure is to provide an image generation device that improves the user interface by offering an indicator of image quality during operation of the device.

According to an embodiment of the present disclosure, an image generation device configured to provide motion artifact compensation may include a light source unit (or light generation unit) configured to emit light toward a target object, a light receiving unit configured to receive an optical signal irradiated onto the target object, a driving unit configured to control an optical movement path, and at least one processor.

The processor may be configured to irradiate light onto the target object to generate at least one scanning image, estimate a motion speed from the scanning image, generate a corrected scanning image by compensating the at least one scanning image based on the estimated motion speed, and generate a final corrected image based on the at least one corrected scanning image.

The processor may generate the at least one scanning image by inputting signal intensities corresponding to a scanning pattern into respective pixels.

The processor may estimate the motion speed based on variations in signal intensities at pixels that are redundantly scanned within the scanning image.

The processor may calculate a sum of deviations of signal intensities at each of the redundantly scanned pixels within the scanning image and estimate, as the motion speed, a speed that minimizes the calculated sum.

The processor may generate the corrected scanning image by assigning the signal intensity of a motion-influenced scanning coordinate to a corrected scanning coordinate based on the motion speed.

The processor may generate the corrected scanning image by compensating the at least one scanning image based on the motion speed and the time at which the motion occurred.

The processor may generate a final scanning image by combining a plurality of corrected scanning images.

The processor may align at least one scanning image adjacent to a first scanning image, calculate a sum of deviations of signal intensities at each of the redundantly scanned pixels in the aligned scanning images, and estimate, as the motion speed, a speed that minimizes the calculated sum.

The processor may, for each of the aligned scanning images, generate a corrected scanning image by assigning the signal intensity of a motion-influenced scanning coordinate to a corrected scanning coordinate based on the motion speed, and may generate a final corrected image by combining the at least one corrected scanning image.

The image generation device may further include an image quality indicator configured to visually notify a user of the quality status of the currently displayed image.

According to an embodiment of the present disclosure, a method of operating an image generation device configured to provide motion artifact compensation may include, generating at least one scanning image by irradiating light onto a target object, (b) estimating a motion speed from the scanning image, (c) generating a corrected scanning image by compensating the at least one scanning image based on the motion speed; and (d) generating a final corrected image based on the at least one corrected scanning image.

In addition, step (a) may include generating the at least one scanning image by inputting signal intensities corresponding to a scanning pattern into respective pixels by the processor.

Step (b) may include estimating the motion speed by the processor based on variations in signal intensities at redundantly scanned pixels included in the scanning image.

Additionally, step (b) may include calculating, by the processor, a sum of deviations of signal intensities at each of the redundantly scanned pixels included in the scanning image, and estimating, as the motion speed, a speed that minimizes the calculated sum.

Step (c) may include assigning, by the processor, the signal intensity of a motion-influenced scanning coordinate to a corrected scanning coordinate based on the motion speed to generate the corrected scanning image.

Step (c) may further include compensating, by the processor, the at least one scanning image based on the motion speed and the time at which the motion occurred to generate the corrected scanning image.

Step (d) may include combining, by the processor, a plurality of corrected scanning images to generate the final scanning image.

Additionally, the method may further include, (e) aligning, by the processor, at least one scanning image adjacent to a first scanning image.

In this case, step (b) may include calculating, by the processor, a sum of deviations of signal intensities at each of the redundantly scanned pixels in the aligned scanning images; and estimating, as the motion speed, a speed that minimizes the calculated sum.

Step (c) may include, for each of the aligned scanning images, assigning, by the processor, the signal intensity of a motion-influenced scanning coordinate to a corrected scanning coordinate based on the motion speed to generate a corresponding corrected scanning image.

Step (d) may include, combining, by the processor, the at least one corrected scanning image to generate the final corrected image.

The method may further include, providing an image quality indicator configured to visually inform the user of the quality status of the currently displayed image.

### BRIEF DESCRIPTION OF THE DRAWINGS

FIG. 1 illustrates an image generation device 100 according to an embodiment of the present disclosure.

FIG. 2 shows an example of a scanning pattern according to an embodiment of the present disclosure.

FIG. 3 illustrates the image generation device 100 according to an embodiment of the present disclosure.

FIG. 4 is an example illustrating a scanning image generation process according to an embodiment of the present disclosure.

FIG. 5 is a flowchart illustrating a motion artifact compensation process according to an embodiment of the present disclosure.

FIG. 6 is an example illustrating the motion artifact compensation process using scanning images, according to an embodiment of the present disclosure.

FIG. 7 is a flowchart illustrating a motion artifact compensation process according to an embodiment of the present disclosure.

FIG. 8 is an example illustrating the motion artifact compensation process using scanning images, according to an embodiment of the present disclosure.

FIG. 9 illustrates an image quality indicator according to an embodiment of the present disclosure.

### DETAILED DESCRIPTION

The specific structural or functional descriptions of the embodiments disclosed in this specification are provided merely for illustrative purposes to explain the concept of the present disclosure. It will be understood that embodiments in accordance with the concept of the present disclosure may be implemented in various forms and are not limited to the examples described herein.

The embodiments of the present disclosure may be subject to various modifications and may take diverse forms. Therefore, specific examples are illustrated in the drawings and described in detail in this specification. However, this is not intended to limit the embodiments to particular forms of disclosure, and it should be understood that all modifications, equivalents, and substitutions that fall within the spirit and scope of the present disclosure are encompassed thereby.

The terms such as “first” and “second” may be used to describe various elements, but the elements should not be limited by such terms. These terms are used only to distinguish one element from another, and, for example, a first element could be referred to as a second element, and similarly, a second element could be referred to as a first element, without departing from the scope of the present disclosure.

The terminology used herein is for the purpose of describing particular embodiments only and is not intended to limit the present disclosure. Unless the context clearly indicates otherwise, the singular expressions include the plural. As used herein, the terms “comprise,” “include,” or the like specify the presence of stated features, integers, steps, operations, elements, and/or components but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. Commonly used terms should be interpreted as having meanings that are consistent with their usage in the context of the relevant technical field and not as idealized or overly formal interpretations unless expressly so defined herein.

The term “and/or” as used herein should be interpreted to include any and all possible combinations of one or more of the associated listed items. Additionally, the term “or” is intended to mean an inclusive “or” rather than an exclusive “or”, unless otherwise specified or unless the context clearly dictates otherwise. For example, the expression “X uses A or B” is to be interpreted to mean that X uses A, or B, or both A and B.

Similarly, the phrase “at least one selected from A and B” may refer to: (1) at least one of A, (2) at least one of B, (3) at least one of A and at least one of B, (4) A and B together, etc.

In this specification, unless otherwise specified or contextually required, singular expressions should be interpreted to include plural expressions, and terms such as “comprise” or “include” do not exclude the possibility of the presence or addition of one or more other elements or features.

Prior to providing detailed descriptions of the drawings, it should be noted that the divisions of components described in this specification are made for the sake of describing their primary functions, and such divisions do not limit the configuration. That is, two or more components described below may be integrated into a single component, or a single component may be divided into two or more components according to finer functional roles. Moreover, each of the components described below may additionally perform part or all of the functions of other components, and vice versa.

In addition, with respect to methods or operation procedures described herein, unless the specific order of the processes is explicitly stated or contextually required, the respective processes may be performed in a different order than that described. That is, the processes may be executed in the described order, substantially simultaneously, or in reverse order.

Hereinafter, preferred embodiments of the present disclosure will be described in detail with reference to the accompanying drawings.

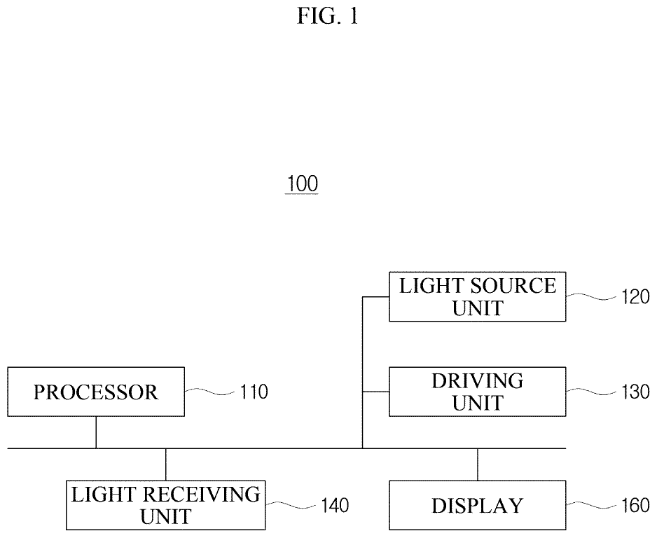

FIG. 1 illustrates an image generation device 100 according to an embodiment of the present disclosure.

### 1. Image Generation Device

The following description relates to an image generation device that may be used to acquire an image of a target object. The image generation device may be an optical device configured to acquire or provide at least one of a reflection image, a fluorescence image, or a transmission image of the target object.

FIG. 1 is a block diagram illustrating the configuration of the image generation device according to an embodiment.

Referring to FIG. 1, the image generation device according to an embodiment may include a processor 110, a light source unit 120, a driving unit 130, a light receiving unit 140, and a display 160.

According to an embodiment, the image generation device may include a LiDAR, laser scanner, or confocal microscope, or any device that generates images using light.

The processor 110 may execute software, programs, or algorithms necessary for generating and correcting images. In other words, the processor 110 may receive electrical signals as input and output electrical signals as well. For example, the processor 110 may execute software or a program for generating an image based on a data acquisition method described below, or may execute an algorithm for image generation.

However, the use of the processor 110 is not limited to the above examples, and the processor 110 may execute any software, program, or algorithm that a general-purpose computing device is capable of performing.

The light source unit 120 may emit light in various wavelength bands, including infrared, ultraviolet, and visible light. The light emitted from the light source unit 120 may be irradiated onto a target object. For example, the light emitted by the light source unit 120 may have a wavelength band of 405 nm, 488 nm, or 785 nm for exciting fluorescent dyes. However, it is not limited thereto, and may include light of a wavelength band for exciting autofluorescent biological substances present in the target object, such as cellular autofluorescence.

Additionally, the light emitted by the light source unit 120 may be either non-amplified light or light amplified by stimulated emission of radiation (hereinafter referred to as a laser).

The driving unit 130 may operate a component located on the optical path such that the path of light emitted from the light source unit 120 is varied as it is irradiated onto the target object. In other words, the driving unit 130 may receive electrical energy or an electrical signal from the processor 110 and drive a component along the optical path.

The component on the optical path may include, for example, an optical fiber 310 that guides the movement of light, or a MEMS mirror that reflects light emitted from the light source unit 120.

For instance, the driving unit 130 may include a driving element such as an electric motor, a magnetic motor, a piezoelectric element, or a thermoelectric element. However, the driving unit 130 is not limited to the above examples and may include any element capable of generating kinetic energy when electrical or magnetic force is applied.

According to an embodiment, the driving unit 130 may operate a component on the optical path in at least one direction. That is, the driving unit 130 may receive an electrical signal and apply force to the component on the optical path along at least one axis.

For example, when a single axis is defined in a space where light is irradiated onto the target object, the driving unit 130 may apply force along both the defined axis and another axis different from the former. In other words, the driving unit 130 may drive the component on the optical path along a first axis and along a second axis different from the first.

As one example, the first axis may be the x-axis and the second axis may be the y-axis, which are perpendicular to each other; however, the axes are not limited thereto.

The light receiving unit 140 may convert optical energy of light returned from the target object into electrical energy and transmit it to the processor 110. In other words, the light receiving unit 140 may obtain information of the returned light in the form of an electrical signal.

Hereinafter, for convenience of explanation, the process in which the light receiving unit 140 obtains light information from the target object and transmits it to the processor 110 may be referred to as the processor 110 “acquiring light information.” However, this does not mean that the processor 110 directly acquires the light information, but rather that the light information acquired by the light receiving unit 140 is delivered to the processor 110.

Likewise, the phrase “the light receiving unit 140 acquires light information” may refer to converting optical energy into electrical energy.

The light information described below may include signal intensity representing the color of light such as grayscale, RGB, CMYK, etc., spatial position information of the light, and temporal information related to the time the light was received. However, for the sake of simplicity, the term “light information” hereinafter may primarily refer to the intensity of the signal.

The light receiving unit 140 may include an image sensor, light-receiving element, imaging device, optical receiver, photodetector, or any other light-detecting component for acquiring light information. For example, the light receiving unit 140 may include a CCD, CMOS, photomultiplier tube (PMT), or photodiode. However, the light receiving unit 140 is not limited to these examples, and any component capable of converting optical energy into electrical energy may be included in the light receiving unit 140.

The display 160 may display the image generated by the processor 110 in a visually recognizable form. In other words, the display 160 may receive the image generated by the processor 110 and output it on a screen to allow a user to view it.

For example, the display 160 may include an image display element such as a CRT, LCD, LED, or LCOS (Liquid Crystal on Silicon). However, the display 160 is not limited to these examples, and any device capable of receiving an electrical signal and displaying an image may be included in the display 160.

According to another embodiment, the image generation device may be provided without the display 160. That is, although FIG. 1 illustrates the image generation device including the display 160, the image generation device is not limited thereto, and may include only the processor 110, the light source unit 120, the driving unit 130, and the light receiving unit 140.

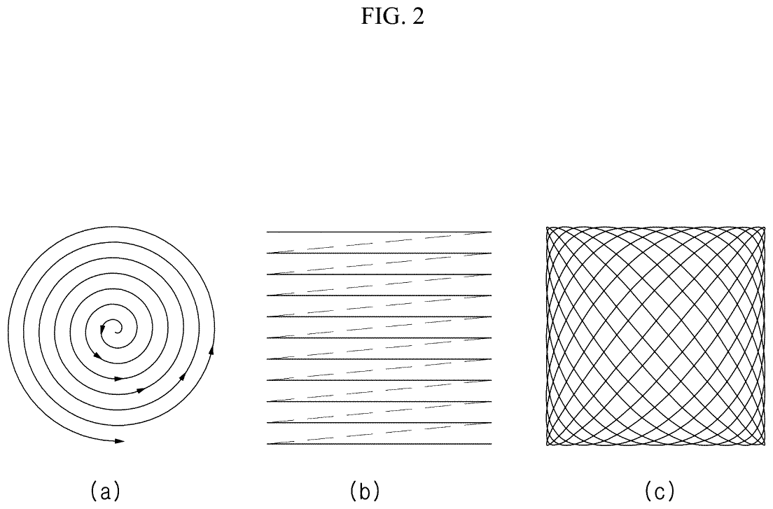

FIG. 2 illustrates examples of scanning patterns according to an embodiment of the present disclosure.

Referring to FIG. 2, FIG. 2(a) shows a spiral pattern, FIG. 2(b) shows a raster pattern, and FIG. 2(c) shows a Lissajous pattern.

According to an embodiment, the image generation device may irradiate light onto a target object such that the path of the irradiated light follows a specific pattern. As a result, the trajectory of the light may exhibit a particular pattern.

The light irradiated onto the target object may follow a defined path for a specific period of time, and overlapping along the same path may occur after that period. In other words, the specific period of time may correspond to the time required to complete one full cycle of the pattern.

Referring to FIG. 2, the light irradiated onto the target object may follow different patterns depending on the electrical signal input to the driving unit 130. For convenience of explanation, the irradiation of light onto the target object may also be referred to as scanning the target object or scanning light over the target object.

For example, referring to FIG. 2(a), when the amplitude of the electrical signal input to the driving unit 130 is varied, the trajectory of the light irradiated onto the target object may form a spiral pattern.

Referring to FIG. 2(b), when the electrical signal input to the driving unit 130 includes a first drive signal that drives the driving unit 130 or a component on the optical path in one axial direction, and a second drive signal that drives the same in a direction perpendicular to the first axis, and when the frequency of the first drive signal and the frequency of the second drive signal differ by an integer multiple, the light trajectory on the target object may form a raster pattern.

Referring to FIG. 2(c), when the electrical signal input to the driving unit 130 includes a first drive signal that drives the driving unit 130 or a component on the optical path in one axial direction, and a second drive signal that drives the same in a different direction from the first, and when the frequencies of the two drive signals differ and are not integer multiples of each other, the light trajectory may form a Lissajous pattern.

Hereinafter, the pattern used by the image generation device will be described as a Lissajous pattern. However, as described in the above embodiments, various patterns may be used by the image generation device.

### 1.1 Image Generation Device Utilizing a Fiber 310

According to an embodiment, an image generation device may be provided in which the light path of light emitted from the light source unit of the image generation device is formed by an optical fiber 310 (hereinafter referred to as “fiber 310”). In other words, the component on the optical path, as previously described, may be the fiber 310.

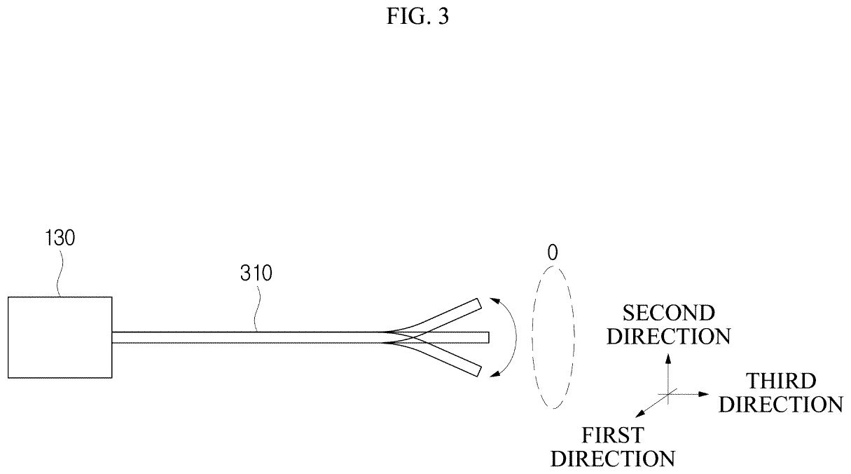

FIG. 3 is a schematic diagram showing a part of an image generation device including the driving unit 130 and the fiber 310 according to an embodiment.

Referring to FIG. 3, at least a portion of the fiber 310 may be housed within at least a portion of the driving unit 130. In other words, at least part of the fiber 310 may be mechanically coupled to the driving unit 130.

Accordingly, when the driving unit 130 receives an electrical signal from the processor 110 and operates in response thereto, the fiber 310 may be driven such that the light irradiated onto a designated area of the target object follows a specific pattern.

As a specific example, when light emitted from the light source unit 120 is irradiated onto a target object, the driving unit 130 may receive an electrical signal configured to generate a Lissajous pattern, and may drive the fiber 310 such that the trajectory pointing toward the target object follows a Lissajous pattern.

### 1.2 Image Generation Using Scanning Patterns

The following describes a method of generating scanning images using a scanning pattern. The scanning image acquired in this context may correspond to a single frame at a specific point in time. The processor may generate a final scanning image by combining at least one scanning image.

When a plurality of final scanning images are continuously generated, the processor 110 may obtain a video of the target object.

According to an embodiment of the present disclosure, acquiring one frame by the processor 110 may include acquiring time information, coordinate information, and light information at predetermined time intervals. Alternatively, acquiring one frame may include generating an image based on the acquired time information, coordinate information, and light information.

According to another embodiment, after acquiring one frame, the processor 110 may generate an image using the coordinate information acquired for each pixel or light information corresponding to the acquired coordinate information.

In other words, since the image generation device according to an embodiment of the present disclosure acquires a scanning image based on the scanning pattern of the driving unit, at least some of the pixels may not be scanned, and accordingly, signal intensity values may not be assigned to such pixels.

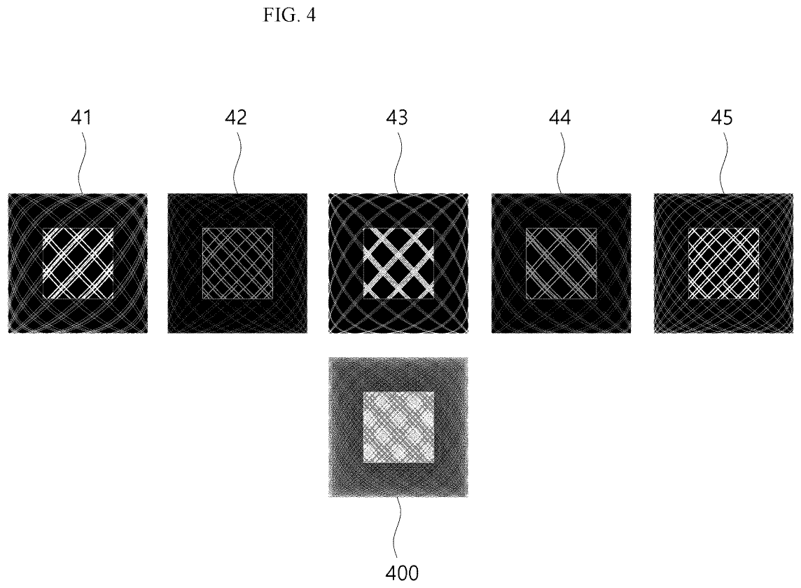

FIG. 4 illustrates an example of scanning image acquisition according to an embodiment of the present disclosure.

Referring to FIG. 4, the processor of the image generation device 100 may generate a final scanning image 400 using at least one or more scanning images 41, 42, 43, 44, and 45.

The first scanning image 41 represents an image in which scanning coordinates and corresponding signal intensities are mapped based on scanning performed by the driving unit in a first frame according to a drive signal.

The second scanning image 42 represents an image acquired in a second frame adjacent to the first frame, in which scanning coordinates and corresponding signal intensities are mapped based on scanning performed by the driving unit in accordance with the drive signal.

Similarly, the third scanning image 43, fourth scanning image 44, and fifth scanning image 45 respectively represent images that include scanning coordinates and corresponding signal intensities acquired in the third, fourth, and fifth frames.

According to an embodiment of the present disclosure, the processor may generate a final scanning image 400 by combining at least one or more of the scanning images 41, 42, 43, 44, and 45.

In FIG. 4, five scanning images are combined to generate the final scanning image; however, this is merely an example for illustrative purposes, and the number of scanning images to be fused is not limited thereto.

When a specific region of a target object is scanned using the image generation device, the device may be moved due to user manipulation. In such a case, if the final scanning image is generated by simply combining at least one scanning image, motion artifacts may occur, resulting in a low-quality image.

The motion artifacts may occur within a single frame due to the fiber 310 being driven to scan the light over a specific area of the target object following a specific pattern (e.g., the patterns shown in FIG. 2). Additionally, motion artifacts may also occur between a specific frame and one or more adjacent frames.

Hereinafter, a method for compensating such motion artifacts will be described.

### 2. Motion Speed Estimation-Based Artifact Compensation Method

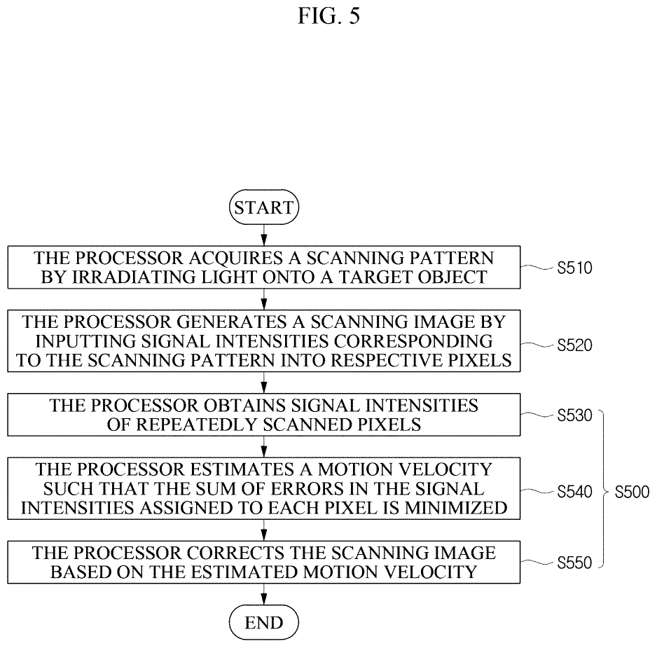

FIG. 5 is a flowchart illustrating a motion artifact compensation process according to an embodiment of the present disclosure.

First, according to an embodiment of the present disclosure, the processor of the image generation device may acquire at least one scanning image (see FIG. 4), which may include a Lissajous scan image.

A Lissajous scan image is based on a pattern formed through signals having specific frequency and phase relationships, and may be generated based on light signals that are repeatedly irradiated onto a specific region of the target object.

Referring to FIG. 5, the processor of the image generation device according to an embodiment of the present disclosure may irradiate light onto a target object to acquire a scanning pattern (S510). Through this process, the signal intensity assigned to each pixel included in the scanning image may be obtained. Here, the signal intensity may include light information or brightness values corresponding to the coordinate information of the scanning image.

The processor may generate a scanning image by inputting the signal intensity corresponding to the scanning pattern into each pixel (S520).

As described above, the scanning image is acquired over a predetermined time corresponding to one frame. Due to the characteristics of Lissajous pattern scanning, the same pixel may be scanned multiple times during a single frame. However, due to motion, the scanning pattern coordinates may be distorted, resulting in different signal intensities being obtained for the same pixel location. According to an embodiment of the present disclosure, the processor may acquire the signal intensity of each redundantly scanned pixel (S530).

According to an embodiment of the present disclosure, the processor may correct the scanning image based on an estimated motion speed. The following describes this process in more detail.

According to an embodiment of the present disclosure, the processor of the image generation device may perform Lissajous scanning over a specific region of the target object via the light source unit.

More specifically, the Lissajous scanning may be defined by the following Equation 1.

$$x ( t ) = A \cdot sin ( 2 π {f}_{x} \cdot t + {∅}_{x} ) \qquad Equation l$$

$$y ( t ) = B \cdot sin ( 2 π {f}_{y} \cdot t + {∅}_{y} ) .$$

Here, x(t) and y(t) represent the coordinates of the Lissajous pattern at a specific time t.

A and B denote the amplitudes (i.e., signal intensities) in the x-axis and γ-axis directions, respectively.

fₓ and f_{y} represent the frequencies in the x-axis and γ-axis directions, and the ratio between these two frequencies determines the shape of the Lissajous pattern.

Øₓ and Ø_{y} represent the phase offsets along the x-axis and γ-axis, respectively.

In an ideal environment, when a specific region of a target object is scanned, the scanning pattern generated by the processor of the image generation device according to an embodiment of the present disclosure remains consistent, as it is based on a predefined combination of frequency and phase.

However, when user-induced motion occurs in the image generation device, the scanning path is affected by the motion, causing variations in signal intensities at intersection points of the scanning pattern. As a result, motion artifacts may occur, and the signal intensities at those intersection points may become inconsistent or distorted.

More specifically, at a particular time t, at least one Lissajous pattern coordinate distorted by motion may be defined by the following Equation 2.

$${x}^{′} ( t ) = A \cdot sin ( 2 π fx \cdot t + ϕ x ) + {v}_{x} t \qquad [ Equation 2 ]$$

$${y}^{′} ( t ) = B \cdot sin ( 2 π fy \cdot t + ϕ y ) + {v}_{y} t$$

Here, x′(t) and y′(t) represent the scanning coordinates distorted by motion.

vₓ and v_{γ} denote the motion speeds in the x-axis and γ-axis directions, respectively.

Øₓ and Ø_{y} represent the phase offsets along the x-axis and γ-axis, respectively.

In contrast, when no motion occurs during scanning, the motion speeds in the x-axis and γ-axis directions are zero. As a result, the signal intensity assigned to any pixel within the scanning pattern remains consistent. Therefore, the signal intensities of redundantly scanned pixels are expected to be similar or identical.

According to an embodiment of the present disclosure, this principle can be used to estimate the motion speed for the purpose of compensating for motion artifacts.

In general, when no motion is present during Lissajous scanning, redundant scanning occurs such that multiple pixels in the scanning image are scanned more than once. In such cases, the light signals measured at the redundantly scanned pixels will be substantially identical.

However, when motion occurs, deviations in the light signal intensities arise among the redundantly scanned pixels within the scanning image.

According to an embodiment of the present disclosure, the processor may estimate the motion speed based on the light signal intensities measured at redundantly scanned pixels in the scanning image of the target object.

Specifically, the processor may acquire the signal intensity for each of the redundantly scanned pixels and estimate the motion speed by performing a calculation that minimizes the sum of deviations in the measured signal intensities.

A more detailed description is provided below based on the following mathematical expression. According to an embodiment of the present disclosure, the processor may insert a plurality of random candidate motion speed values and derive the motion speed that results in the minimum sum of errors across all pixel values (S540). Through this process, the motion speed occurring in the scanning image may be estimated.

More specifically, the processor may estimate the motion speed based on the error in signal intensity at the intersection points, calculated from the coordinates of the scanning pattern.

For example, the error in signal intensity may include the variance or standard deviation of signal intensities at redundantly scanned pixels (i.e., intensity variance).

This method can be expressed by the following Equation 3.

$$Find {ϕ}_{x} , {ϕ}_{y} , {v}_{x} , {v}_{y} such that \qquad [ Equation 3 ]$$

$$To Minimize {{\sum }_{i = 1 ∼ {N}_{x}}}_{j = 1 ∼ {N}_{y}} [ {Var}_{k = 0 , Nscan} [ {I}^{k} ( {x}_{i} , {y}_{j} ) ] ]$$

$$for {ϕ}_{\text{?}} , {ϕ}_{y} in [ 0 , π ] {v}_{x} , {v}_{y} in [ 0 , V ]$$

$$where$$

$${I}^{k} ( {x}_{i} , {y}_{j} ) = I at {x}^{k} = {x}_{i} , {y}^{k} = {y}_{\text{?}}$$

$${x}^{k} = X Sin ( 2 π {f}_{\text{?}} {t}^{k} + {ϕ}_{x} ) + {v}_{\text{?}} {t}^{k}$$

$${y}^{k} = Y Sin ( 2 π {f}_{y} {t}^{k} + {ϕ}_{y} ) + {v}_{y} {t}^{k}$$

$$\text{?} \text{indicates text missing or illegible when filed}$$

I denotes the signal intensity at a given coordinate.

Equation 3 may be interpreted as follows: when k instances of redundant scanning occur at the same pixel, the error (e.g. such as the variance) between each measured signal intensity I^{k} at the redundant scanning points (x^{k}, y^{k}) and a predetermined reference intensity value may be calculated, and the motion speed may be estimated by minimizing this error.

As described above, the processor may randomly input candidate motion speeds into Equation 3 in order to estimate the actual motion speed.

The processor may estimate the motion speed as the value that minimizes the sum of differences in signal intensity between the observed signal and the corrected signal.

Through this process, the image generation device may estimate the motion speed and compensate for displacement, thereby ensuring coordinate consistency at redundantly scanned points.

According to an embodiment of the present disclosure, the processor may also derive the motion speed by comparing the signal intensity of each pixel in the scanning images, for each randomly assigned candidate motion speed, with a predefined reference intensity.

The predefined reference intensity may be determined during calibration of the image generation device under motion-free conditions.

In addition, if the estimated motion speed varies over the scanning period and a plurality of motion speeds are obtained as a result, the processor may calculate the average motion speed during the scanning period and perform the correction based on that average value.

Finally, the processor may correct the scanning image based on the estimated motion speed (S550). Specifically, according to an embodiment of the present disclosure, the processor may generate a corrected scanning image based on the estimated motion velocity and the scanning time.

Additionally, the processor may correct the scanning image by assigning the signal intensity of a motion-affected scanning coordinate to a corrected scanning coordinate based on the estimated motion speed.

Through this process, the signal intensity at the scanning intersections can be maintained consistently, and distortion caused by motion artifacts can be effectively eliminated.

Accordingly, the processor may effectively compensate for motion artifacts in each of the plurality of scanning images.

Meanwhile, according to the embodiment described in Equation 3, the image generation device may also perform correction to obtain an optimal phase.

Specifically, the image generation device exhibits a characteristic in which the same points are scanned multiple times during the scanning process, allowing for consistent signal intensity values to be secured. However, when phase distortion occurs in the Lissajous pattern (in either the x- or y-direction), the variance of signal intensity at redundantly scanned points increases, which may degrade image quality.

To address this issue, the processor according to an embodiment of the present disclosure may search for an optimal phase value that minimizes the intensity variance at redundantly scanned points.

Motion speed and phase distortion may occur simultaneously in a Lissajous pattern. Therefore, rather than handling them independently, it is preferable to perform a joint optimization of both motion speed and phase in order to achieve more accurate correction.

As described above, using Equation 3, both the phase (x,y) phi and the motion velocity (vₓ, v_{γ}) can be simultaneously derived in a manner that minimizes the intensity variance at redundantly scanned points.

It is noted, however, that the above embodiment assumes that the motion occurring within a single frame is relatively linear or simple in nature. Based on this assumption, it becomes easier to estimate the resulting motion velocity and positional shift. Therefore, it is preferable to perform motion artifact compensation within a single frame under such conditions.

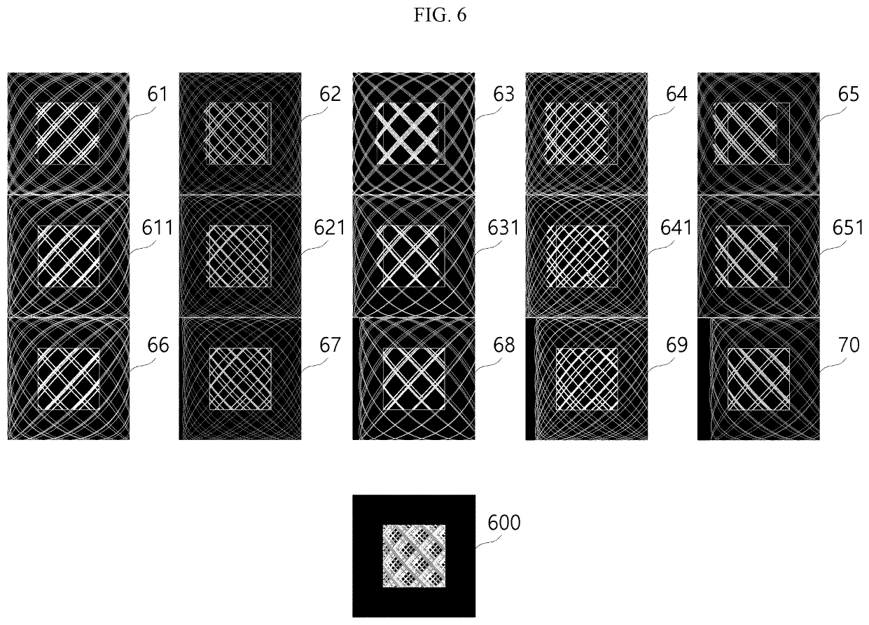

FIG. 6 is an example scanning image illustrating a method of correcting motion artifacts in actual scanning images according to an embodiment of the present disclosure.

Referring to FIG. 6, an example is shown in which horizontal motion artifacts occur in each of a plurality of adjacent scanning images 61, 62, 63, 64, and 65 as the image generation device moves in the horizontal direction.

Each of the scanning images 61 to 65 among the plurality of scanning images represents a frame without any correction.

Each of the scanning images 611 to 651 among the plurality of scanning images represents an image in which intra-frame motion artifacts have been removed.

Each of the scanning images 66 to 70 among the plurality of scanning images represents an image corrected for inter-frame shift (e.g. in which a shift in the X-direction has occurred).

In the case of the first scanning image 61, a scanning pattern corresponding to frame 1, the motion speed v is 0 or the relative time t is 0 regardless of the motion speed v is provided.

In the case of the second scanning image 62, corresponding to frame 2, a motion artifact occurs due to motion at speed v for a certain time t.

Compared to the second scanning image, the third scanning image 63, corresponding to frame 3, shows an additional motion artifact caused by motion at the same speed v for another duration t. Similarly, the fourth scanning image 64 and the fifth scanning image 65 correspond to frames 4 and 5, respectively, each exhibiting accumulated motion artifacts over time.

### 2.1 Intra-Frame Motion Compensation (S550-1)

According to an embodiment of the present disclosure, the processor may estimate the motion speed for each of the first through fifth scanning images (61 to 65) based on Equation 3.

For example, in the case of the first scanning image 61, if redundant scanning occurs at the same pixel, the processor may estimate the motion speed that minimizes the error between the signal intensity at the redundantly scanned coordinates in the first scanning image and a predefined reference signal intensity.

To perform this operation, the processor may randomly input candidate (or random) motion speeds into Equation 3.

The processor may estimate the motion speed as the value that minimizes the sum of intensity differences between the observed signals and the corrected signals.

Through this process, the image generation device can estimate the motion speed and compensate for coordinate displacement present within each scanning image, thereby ensuring coordinate consistency at redundantly scanned points.

This process may be performed for each of the second through fifth scanning images (62 to 65). Accordingly, each of the plurality of scanning images 611 to 651 may be generated through the above-described process.

### 2.2 Scanning Image Shifting (S550-2)

Subsequently, the processor according to an embodiment of the present disclosure may correct each scanning image based on the estimated motion speed and the time during which the motion occurred.

Specifically, in each of the first through fifth scanning images (611 to 651) on which step S550-1 has been performed, the motion may be compensated by shifting in a direction opposite to the direction of the estimated motion speed, by an amount corresponding to one frame duration.

For example, the processor may shift the second scanning image 62 horizontally by one frame in accordance with the estimated second motion speed. Likewise, the processor may shift the third scanning image 63 horizontally by two frames based on the estimated third motion speed. The same process may also be applied to the fourth and fifth scanning images.

As a result, the processor may generate corrected scanning images by shifting each frame based on the estimated motion speed. For instance, the corrected second scanning image 67 may be generated from the original second scanning image 62.

Similarly, the corrected third, fourth, and fifth scanning images 68, 69, and 70, respectively, may be generated.

According to an embodiment of the present disclosure, the processor may generate a final scanning image 600 by combining at least one or more of the scanning images 66, 67, 68, 69, and 70. Hereinafter, a motion artifact compensation method using image matching is described as a simpler alternative approach.

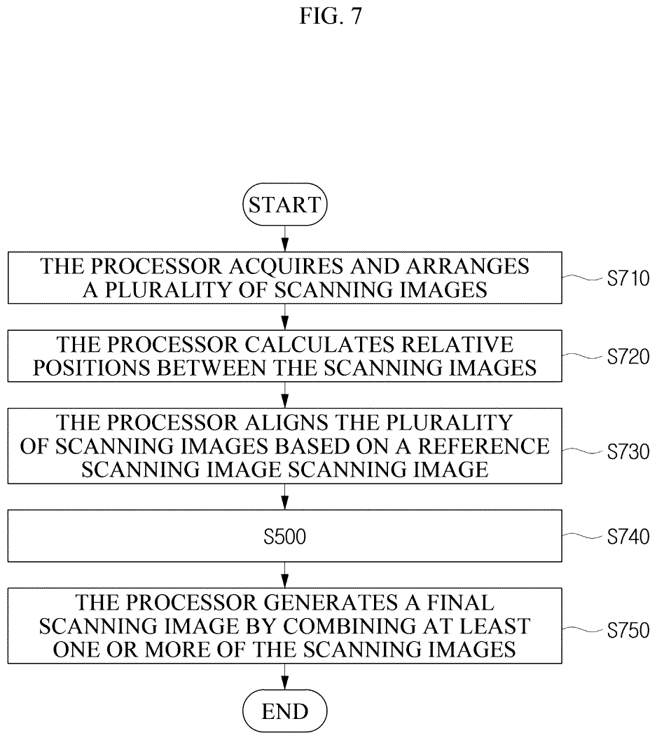

FIG. 7 is a flowchart illustrating a method of compensating for motion artifacts using image matching, according to an embodiment of the present disclosure.

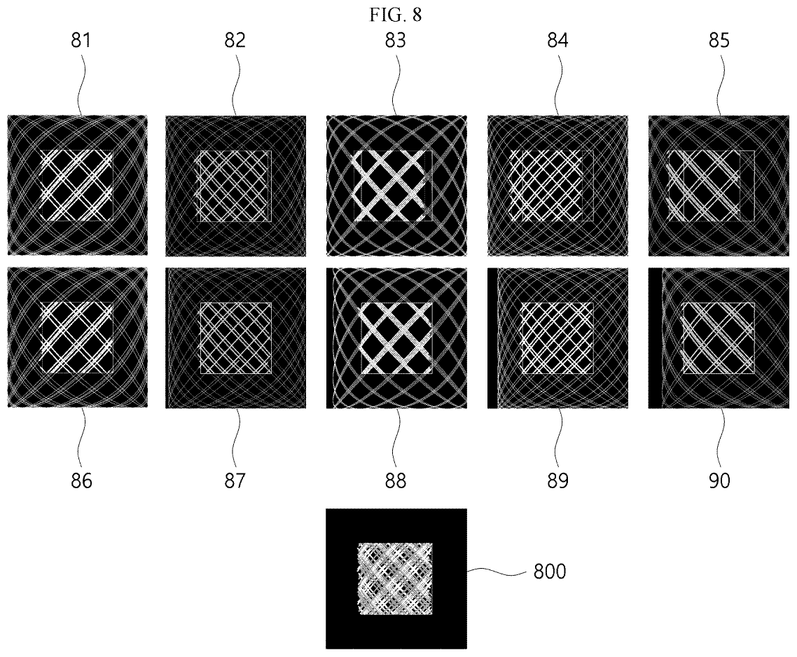

FIG. 8 is an example of scanning images processed using the motion artifact compensation method based on image matching, according to an embodiment of the present disclosure.

### 2.3 Image Matching and Motion Speed Estimation-Based Artifact Compensation Method

According to an embodiment of the present disclosure, the image generation device may generate a final output image by combining a plurality of scanning images to produce a continuous image stream.

In this section, a simplified motion artifact compensation method is described, which utilizes image matching and motion speed estimation as an alternative to the previously described 2.1 Intra-Frame Motion Compensation and 2.2 Scanning Image Shifting methods.

According to an embodiment of the present disclosure, the processor of the image generation device may perform image matching between adjacent frames.

Specifically, the image matching algorithm may include techniques for identifying feature points or similar regions between different images or frames in order to align or compare the two images.

According to an embodiment of the present disclosure, the processor of the image generation device may perform both image matching between adjacent frames and motion artifact compensation.

According to an embodiment of the present disclosure, the processor may acquire a plurality of scanning images and align each adjacent scanning image with reference to a first scanning image (S710).

In this case, the alignment between each adjacent scanning image may refer to an arrangement in which the frames are aligned in the order of their generation times while having partially overlapping regions with each other.

The processor may detect feature points between adjacent scanning images and calculate the relative position of each scanning image based on the matched feature points (S720).

According to an embodiment of the present disclosure, the processor may apply the calculated transformation matrix to align each adjacent scanning image with the reference scanning image (S730). Through this process, the adjacent images can be aligned within the same coordinate system, and inter-frame misalignments may be corrected.

According to an embodiment of the present disclosure, the processor may perform the motion artifact compensation process described in S500 of FIG. 5 for each of the aligned scanning images (S740). Specifically, the processor may analyze the variation in signal intensity at the intersections of the scanning pattern and estimate the velocity that minimizes the variance of the signal intensity. Based on this estimation, the processor can correct image distortion caused by motion.

Meanwhile, in consideration of computational complexity, the step S740 may be omitted.

According to an embodiment of the present disclosure, the processor may generate a final scanning image by fusing at least one or more of the corrected scanning images (S750).

During the fusion process, the processor may apply weighted averaging to the signal intensity values of each frame in order to ensure uniformity in the signal intensity of the final image.

Referring to FIG. 8, an example is illustrated in which horizontal motion artifacts occur in each of a plurality of scanning images 81, 82, 83, 84, and 85 as the image generation device moves in the horizontal direction.

In the case of the first scanning image 81, a scanning pattern corresponding to frame 1, the motion speed v is 0 or the relative time t is 0 regardless of the motion speed v is provided.

In the case of the second scanning image 82, corresponding to frame 2, a motion artifact occurs due to motion at speed v for a duration of time t. In the third scanning image 83, corresponding to frame 3, an additional motion artifact occurs for the same speed v over another duration t, compared to the second image.

Similarly, the fourth and fifth scanning images 84 and 85 correspond to frames 4 and 5, respectively, each exhibiting further accumulated horizontal motion artifacts.

According to an embodiment of the present disclosure, the processor may acquire a plurality of scanning images and align the adjacent scanning images with reference to the first scanning image 81. For example, the second scanning image 82, third scanning image 83, fourth scanning image 84, and fifth scanning image 85 may be aligned based on the first scanning image 81.

To achieve this, the processor may detect feature points between each pair of scanning images and calculate the relative position of each image based on the matched feature points.

Through the above process, image matching may be performed between the first through fifth scanning images using the first scanning image as a reference, so that at least some of the pixels may be aligned.

Subsequently, motion artifacts present in each of the scanning images 81 through 85 must be corrected.

According to an embodiment of the present disclosure, the processor may estimate the motion speed for each scanning image by minimizing the error between the signal intensity at redundantly scanned coordinates and a predefined reference intensity, in cases where redundant scanning occurs at the same pixel.

To perform this operation, the processor may randomly input candidate motion speeds into Equation 3.

The processor may estimate the motion speed as the value that minimizes the sum of differences in signal intensity between the observed signals and the corrected signals.

Finally, the processor may correct each of the plurality of scanning images based on the estimated motion speed, thereby generating corrected scanning images 86, 87, 88, 89, and 90.

According to an embodiment of the present disclosure, the processor may generate a final scanning image 800 by combining at least one or more of the corrected scanning images 86 through 90.

Through the above embodiment, the image generation device may provide a more efficient motion artifact compensation method by performing image matching across the plurality of scanning images first and then estimating the motion speed for each image to generate the final scanning image, as in the second embodiment (see FIG. 7), rather than estimating motion speed and shifting each scanning image individually within a single frame, as in the first embodiment (see FIG. 5).

### 3. Use Cases of the Image Generation Device

The Lissajous scanning-based image generation device according to the present disclosure may be utilized in real-time biopsy systems. For example, during medical imaging, motion artifacts can be effectively removed to provide clearer images, thereby improving diagnostic accuracy.

In addition, the present disclosure may be applied to various fields such as industrial non-destructive testing, high-precision 3D scanning, and LiDAR sensors in autonomous driving systems.

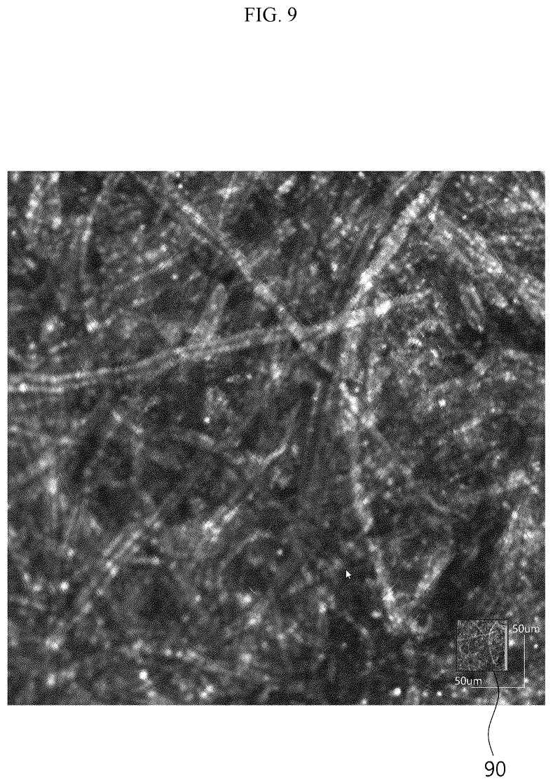

FIG. 9 is a diagram illustrating a user interface according to an embodiment of the present disclosure.

According to an embodiment of the present disclosure, the image generation device may further include a user interface 90 configured to indicate the quality of the scanning image.

Specifically, the image generation device may provide an image quality indicator to visually inform the user of the current quality status of the displayed image. This function may analyze and display the image quality in real time, thereby assisting the user in making informed decisions regarding image capture.

According to an embodiment of the present disclosure, the image quality indicator 90 may be presented as a small preview window along with a vertical bar located at the bottom-right corner of the final scanning image. This allows the user to intuitively recognize the quality status of the image.

Referring to FIG. 9, the image quality indicator according to the present embodiment may be classified into three states
Not Displayed: When the image quality is low and capture is not recommended, the indicator is not displayed.
Displayed, Blue Bar: When the image quality is moderate, and pressing the capture button may initiate post-processing to improve image quality.
Displayed, Green Bar: When the image quality is high, and pressing the capture button allows the image to be finalized and saved with minimal post-processing.

Additionally, in an embodiment of the present disclosure, when a high-quality image is detected and indicated by a green bar, the indicator may be maintained for two seconds unless a new high-quality image is detected. This ensures the user has sufficient time to recognize and capture the optimal image.

The image quality indicator function according to the present disclosure enhances user convenience and supports the acquisition of optimal image quality during scanning operations.

According to an embodiment of the present disclosure, motion artifacts that occur during the use of the image generation device can be effectively compensated.

According to another embodiment of the present disclosure, the quality of multi-frame fusion can be improved through alignment between adjacent frames.

According to still another embodiment of the present disclosure, by performing fusion of a plurality of scanning images based on alignment between adjacent frames, it is possible to enhance image quality while minimizing the computational load associated with image reconstruction and correction.

Those skilled in the art will understand that various illustrative logical blocks, modules, processors, means, circuits, and algorithm steps described in connection with the embodiments disclosed herein can be implemented as electronic hardware, various forms of program or design code (referred to herein for convenience as “software”), or a combination thereof.

The above-described disclosure may be implemented in the form of a computer-readable code stored on a program-recorded medium. A machine-readable recording medium refers to any type of recording device in which data readable by a computer system can be stored. Examples of computer-readable media include, but are not limited to, hard disk drives (HDDs), solid state drives (SSDs), silicon disk drives (SDDs), read-only memory (ROM), random access memory (RAM), CD-ROMs, magnetic tapes, floppy disks, and optical data storage devices.

In one embodiment, the recording medium may be a memory. In another embodiment, the recording medium may be implemented in a distributed manner across computer systems connected via a network. The software may be stored and executed in a distributed fashion. The recording medium may be a non-transitory recording medium. The term “non-transitory recording medium” may refer to a tangible medium that physically exists, regardless of whether the data stored thereon is stored permanently or temporarily.

What is claimed is:

1. An image generation device providing a motion artifact correction function, comprising:
a light source unit configured to emit light irradiated onto a target object;
a light receiving unit configured to receive optical signals reflected from the target object;
a driving unit configured to control a light propagation path; and
at least one processor,
wherein the processor is configured to:
irradiate light onto the target object to generate at least one scanning image;
estimate a motion speed of the scanning image;
generate a corrected scanning image by correcting the at least one scanning image based on the estimated motion speed; and
generate a final corrected image based on the at least one corrected scanning image.

2. The image generation device of claim 1,
wherein the processor is configured to generate the at least one scanning image by inputting signal intensity values corresponding to a scanning pattern into respective pixels.

3. The image generation device of claim 1,
wherein the processor is configured to estimate the motion speed based on variations in signal intensity at redundantly scanned pixels included in the scanning image.

4. The image generation device of claim 1,
wherein the processor is configured to calculate a sum of intensity variations at each of the redundantly scanned pixels included in the scanning image and estimate, as the motion speed, the speed that minimizes the sum.

5. The image generation device of claim 1,
wherein the processor is configured to generate the corrected scanning image by assigning the signal intensity of a motion-affected scanning coordinate to a corrected coordinate based on the estimated motion speed.

6. The image generation device of claim 1,
wherein the processor is configured to generate the corrected scanning image by correcting the at least one scanning image based on the motion speed and the time at which the motion occurred.

7. The image generation device of claim 1,
wherein the processor is configured to generate the final scanning image by combining a plurality of corrected scanning images.

8. The image generation device of claim 1,
wherein the processor is configured to:
align at least one scanning image adjacent to a first scanning image;
calculate a sum of intensity variations at each redundantly scanned pixel in the aligned image; and
estimate, as the motion speed, the speed that minimizes the sum.

9. The image generation device of claim 8,
wherein the processor is configured to:
generate a corrected scanning image for each of the aligned scanning images by assigning the signal intensity of a motion-affected scanning coordinate to a corrected coordinate based on the estimated motion speed; and
generate the final corrected image by combining at least one of the corrected scanning images.

10. The image generation device of claim 1,
further comprising an image quality indicator configured to visually inform a user of a quality status of a currently displayed image.

11. A method for operating an image generation device providing a motion artifact correction function, comprising:
irradiating light onto a target object to generate at least one scanning image;
estimating a motion speed of the scanning image;
generating a corrected scanning image by correcting the at least one scanning image based on the estimated motion speed; and
generating a final corrected image based on the at least one corrected scanning image.

12. The method of claim 11,
wherein step (a) comprises generating the at least one scanning image by inputting signal intensity values corresponding to a scanning pattern into respective pixels by a processor.

13. The method of claim 11,
wherein step (b) comprises estimating the motion speed by a processor based on variations in signal intensity at redundantly scanned pixels included in the scanning image.

14. The method of claim 11,
wherein step (b) comprises:
calculating, by a processor, a sum of intensity variations at each of the redundantly scanned pixels included in the scanning image; and
estimating, as the motion speed, the speed that minimizes the sum.

15. The method of claim 11,
wherein step (c) comprises generating, by a processor, the corrected scanning image by assigning the signal intensity of a motion-affected scanning coordinate to a corrected coordinate based on the estimated motion speed.

16. The method of claim 11,
wherein step (c) comprises correcting, by a processor, the at least one scanning image based on the motion speed and the time at which the motion occurred, to generate the corrected scanning image.

17. The method of claim 11,
wherein step (d) comprises generating, by a processor, the final scanning image by combining a plurality of corrected scanning images.

18. The method of claim 11, further comprising:
(e) aligning, by a processor, at least one scanning image adjacent to a first scanning image; and
wherein step (b) comprises:
calculating a sum of intensity variations at each redundantly scanned pixel in the aligned image; and
estimating, as the motion speed, the speed that minimizes the sum.

19. The method of claim 18,
wherein step (c) comprises generating, for each aligned scanning image, a corrected scanning image by assigning the signal intensity of a motion-affected scanning coordinate to a corrected coordinate based on the estimated motion speed; and
wherein step (d) comprises generating the final corrected image by combining at least one of the corrected scanning images.

20. The method of claim 11, further comprising:
displaying, by the image generation device, an image quality indicator configured to visually inform a user of a quality status of a currently displayed image.
